(19) United States
(12) Patent Application Publication
(10) Pub. No.: US 2024/0381303 A1
(43) Pub. Date: Nov. 14, 2024

(54) Method And Apparatus For Improving Positioning By Data Augmentation In Mobile Communications

(71) Applicant: MediaTek Singapore Pte. Ltd., Singapore (SG)

(72) Inventors: Pengli Yang, Shanghai (CN); Mingwei Jie, Shanghai (CN); Chiao-Yao Chuang, Hsinchu City (TW); Xuancheng Zhu, Shanghai (CN)

(21) Appl. No.: 18/652,827

(22) Filed: May 2, 2024

(30) Foreign Application Priority Data
May 12, 2023 (WO) PCT/CN2023/093944
Apr. 26, 2024 (CN) 202410517011.0

(51) Int. Cl. H04W 64/00; G06N 20/00

(52) U.S. Cl. CPC H04W 64/006; G06N 20/00

(57) ABSTRACT

Various solutions for improving positioning by data augmentation for artificial intelligence/machine learning (AI/ML) positioning with respect to an apparatus in mobile communications are described. The apparatus may obtain a data input sample. The apparatus may perform a data augmentation to generate an augmented training data based on the data input sample. The apparatus may perform a model training on a positioning model based on the augmented training data. The apparatus may determine a position information of the apparatus by the positioning model.

### CROSS REFERENCE TO RELATED PATENT APPLICATION(S)

The present disclosure is part of a non-provisional application claiming the priority benefit of PCT Application No. PCT/CN2023/093944, filed 12 May 2023, and China Application No. 202410517011.0, filed 26 Apr. 2024. The contents of aforementioned applications are herein incorporated by reference in their entirety.

### TECHNICAL FIELD

The present disclosure is generally related to mobile communications and, more particularly, to improving positioning by data augmentation for artificial intelligence/machine learning (AI/ML) positioning with respect to apparatus in mobile communications.

### BACKGROUND

Unless otherwise indicated herein, approaches described in this section are not prior art to the claims listed below and are not admitted as prior art by inclusion in this section.

In 5th-generation (5G) New Radio (NR) mobile communications, artificial intelligence (AI)/machine learning (ML) schemes are introduced to facilitate positioning for an apparatus (e.g., user equipment (UE)). The performance of AI/ML model depends on the sample density (e.g., #samples/meter2) of training dataset. The larger the training dataset size (i.e., smaller average distance between samples), the smaller the positioning error (e.g., in meters), until a saturation point is reached. However, datasets are not that easy to access/acquire, especially for dataset with labels, and it is difficult to obtain large enough or balanced datasets (e.g., uniformly distributed UE). This often leads to a major problem when attempting to train one of these AI/ML models on an incomplete, unbalanced (i.e., un-uniformly distributed), or privacy-challenged dataset.

Typically, data augmentation techniques can be used to solve these problems, thereby enhancing AI/ML positioning performance. In this way, the overhead of training dataset collection can also be reduced. Accordingly, how to improve performance of positioning with limited data samples becomes an important issue in the newly developed wireless communication network. Therefore, there is a need to provide proper schemes to improve positioning by using data augmentation techniques in mobile communications.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

An objective of the present disclosure is to propose solutions or schemes that improving positioning by data augmentation for artificial intelligence/machine learning (AI/ML) positioning with respect to apparatus in mobile communications.

In one aspect, a method may involve a training entity transmitting a request for an assistance data to a data collection entity. The method may also involve the training entity receiving the assistance data from the data collection entity. The method may further involve the training entity performing a model training on a positioning model based on the assistance data. The method may further involve the training entity determining a position information by the positioning model.

In one aspect, a method may involve a data collection entity receiving a request for an assistance data from a training entity. The method may also involve the data collection entity generating the assistance data according to the request. The method may further involve the data collection entity transmitting the assistance data to the training entity. The assistance data may comprise at least one of a set of delay profiles of channels, a set of labels labelling each delay profile, a set of quality indicators of the delay profiles and the labels, a set of augmented training data, a set of data augmentation indicators for the augmented training data, a set of parameters or timing shift values associated with the augmented training data, an actual dataset size, and statistical information associated with a data augmentation method.

In one aspect, a method may involve an apparatus obtaining a data input sample. The method may also involve the apparatus performing a data augmentation to generate an augmented training data based on the data input sample. The method may further involve the apparatus performing a model training on a positioning model based on the augmented training data. The method may further involve the apparatus determining a position information of the apparatus by the positioning model.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example jittering augmentation method under schemes in accordance with implementations of the present disclosure.

FIG. 3 is a diagram depicting an example timing shift augmentation method under schemes in accordance with implementations of the present disclosure.

FIG. 4 is a block diagram of an example positioning system in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improving positioning by data augmentation for AI/ML positioning with respect to apparatus in mobile communications. According to the present disclosure, a number of possible solutions may be implemented separately or jointly. That is, although these possible solutions may be described below separately, two or more of these possible solutions may be implemented in one combination or another.

AI/ML positioning comprises direct AI/ML positioning and AI/ML assisted positioning. The performance of both AI/ML positioning models can be improved by collecting more training dataset. The present disclosure provided schemes for obtaining/generating augmented data for AI/ML model training. Data augmentation has been a crucial task when the available data are unbalanced or insufficient. Traditionally, in fields such as image recognition, different transformations have been applied to data such as cropping, scaling, mirroring, color augmentation, or translation. However, these algorithms cannot be applied directly to positioning. Therefore, there is a need to provide proper data augmentation schemes that is available for positioning in mobile communications.

In view of the above, the present disclosure proposes some schemes pertaining to data augmentation techniques that can be applied directly to positioning with respect to apparatus (e.g., UE or network apparatus) in mobile communications. According to the schemes of the present disclosure, the proposed data augmentation methods comprise at least one of a jittering transformation and a timing shift transformation, which add noise and timing offset to original input samples respectively to synthesize new datasets. For jitter transformation, the added noise is assumed to conform to a Gaussian distribution. For timing shift transformation, the added timing offset is assumed to conform to a truncated Gaussian distribution with a mean of μ=0. These two methods all apply modifications directly to the data input samples. In addition, Conditional Variational Autoencoding (CVAE) is an AI data augmentation method that learns the probability distributions of the original data and generates new samples following that distribution. By applying these data augmentation methods, the dataset size that can be used for positioning may be increased and expanded based on original data samples. Thus, the performance of positioning can be improved without significant efforts on collecting additional data samples.

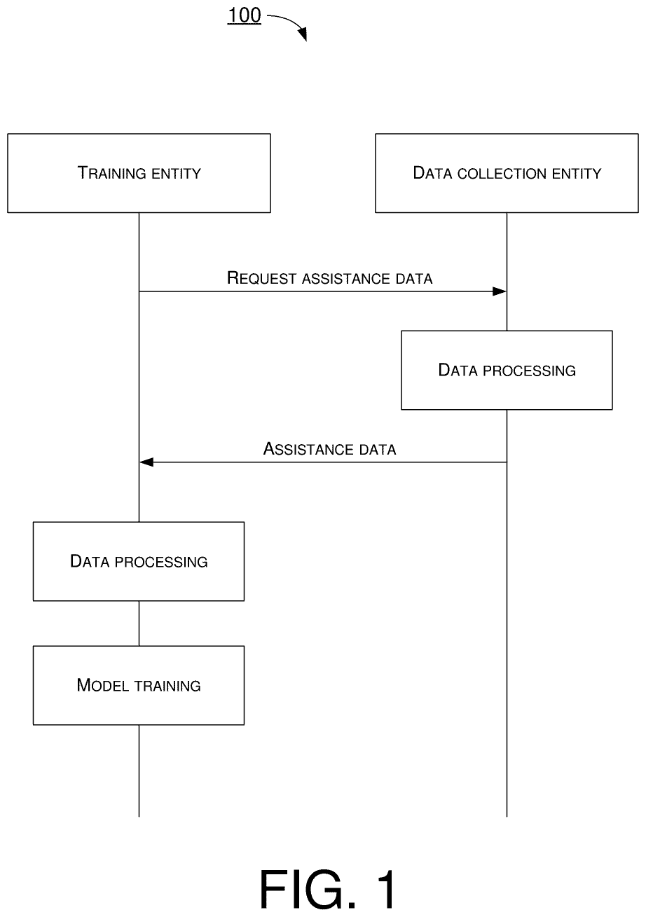

FIG. 1 illustrates an example scenario 100 under schemes in accordance with implementations of the present disclosure. Scenario 100 involves at least a training entity and a data collection entity, which may be a part of a wireless communication network (e.g., an LTE network, a 5G/NR network, an IoT/NB-IoT/IIoT network, a 6G network and/or an NTN network). For example, each of the training entity and the data collection entity may comprise at least one of a positioning reference unit (PRU) (e.g., a device with a known position), a user equipment (UE), a base station, a location management function (LMF), a server and a network node (e.g., gNB). Scenario 100 illustrates a framework of positioning by using data augmentation methods. The training entity may transmit a request for an assistance data to the data collection entity. The request may comprise at least one of a data augmentation indicator to indicate a type of data augmentation needed, a needed/preferred dataset size, and statistical information associated with a data augmentation method. For example, the data augmentation indicator may indicate which data augmentation method is preferred/adopted. If a timing shift augmentation method is chosen, the request may comprise a referred standard deviation of timing error distribution (e.g., synchronization error and/or UE transmit/receive (TX/RX) timing error). The data collection entity may receive the request from the training entity.

The data collection entity may perform a data processing to generate the assistance data according to the request. The data collection entity may transmit the assistance data to the training entity. The assistance data may comprise, for example and not limited to, at least one of a set of delay profiles of channels, a set of labels labelling each delay profile, a set of quality indicators of the delay profiles and the labels, a set of augmented training data, a set of data augmentation indicators for the augmented training data, a set of parameters or timing shift values associated with the augmented training data, an actual dataset size, and statistical information associated with a data augmentation method. The channel delay profile may comprise at least one of a channel impulse response (CIR), a power delay profile (PDP) and a reference signal received power (RSRP). The label may comprise a location information.

The training entity may receive the assistance data from the data collection entity. After obtaining the assistance data, the training entity may perform a model training on a positioning model based on the assistance data. The positioning model may comprise an AI/ML positioning model. Then, the training entity may determine/infer a position information by the positioning model. The position information may comprise an estimated location of the training entity and/or a soft information related to the estimated location. For example, the estimated location may comprise a coordinate information of the training entity. The soft information may comprise the variance or standard deviation of the estimated location.

In some implementations, a data augmentation may be performed by the training entity to generate more training datasets. The augmented training data may be used to train the positioning model to improve the positioning accuracy. Specifically, the training entity may have an original data input sample (i.e., original dataset). The original data input sample may comprise at least one of a CIR, a PDP and an RSRP. These data input sample may be acquired by performing some measurements, or may be received from other apparatus. The training entity may transmit the data input sample to the data collection entity. The data input sample may be used by the data collection entity to generate the assistance data. The assistance data may be associated to the data input sample. For example, the training entity may transmit the data input sample to the data collection entity and request at least one label for each data input sample (e.g., CIR, PDP or RSRP) from the data collection entity. The assistance data generated by the data collection entity may associate to the data input sample and the at least one label. In another example, the training entity may obtain the labels for the data input sample by itself during a training data collection stage.

After receiving the assistance data from the data collection entity, the training entity may perform the data augmentation to generate the augmented training data based on the assistance data (e.g., the data input sample and the labels). For example, the training entity may perform the data augmentation by at least one of a jittering augmentation method, a timing shift augmentation method, an AI augmentation method and an ML augmentation method. Then, the training entity may use the augmented training data to perform the model training on the positioning model. After the model training, the positioning accuracy can be improved. Accordingly, by using the data augmentation, the training entity is able to improve accuracy of the positioning model based on the original data input sample. The training entity does not need to collect more data input sample for model training.

In some implementations, a data augmentation may be performed by the data collection entity to generate more training datasets. Specifically, the data collection entity may receive the original data input sample from the training entity. The data input sample may comprise at least one of a CIR, a PDP and an RSRP. The data collection entity may also receive the request for the assistance data from the training entity. The request may comprise the data augmentation indicator which may indicate which data augmentation method is needed/preferred, and a needed/preferred dataset size (e.g., the amount of requested data). The request may also comprise the statistical information associated with the augmentation method. For example, if the timing shift augmentation method is chosen, the request may comprise a referred standard deviation of timing error distribution (e.g., synchronization error and/or UE transmit/receive (TX/RX) timing error). Then, the data collection entity may perform the data processing to generate the assistance data. For example, the data collection entity may add at least one label for the data input sample. The assistance data may be associated to the data input sample and the at least one label. The data processing may comprise performing data augmentation and adding the data augmentation indicator to each sample to indicate whether data augmentation is performed and which data augmentation method is used. For example, the data augmentation indicator may indicate that the new data is generated by the data augmentation method #N. The data augmentation method may comprise at least one of a jittering augmentation method, a timing shift augmentation method, an AI augmentation method and an ML augmentation method.

In some cases, the data collection entity may collect the original data input sample (e.g., CIR, PDP or RSRP) by itself. The data collection entity may perform some measurements to obtain the original data input sample or acquire the original data input sample from other database. After receiving the request from the training entity, the data collection entity may perform the data processing based on the original data input sample to generate the assistance data. The data processing may comprise adding data augmentation indicator to each sample to indicate which data augmentation method is used or whether data augmentation is performed, and/or performing the data augmentation.

After the data processing, the data collection entity may transmit at least one of the assistance data, the actual dataset size and the statistical information associated with data augmentation method to the training entity. The training entity may determine whether to perform the data augmentation or not and which samples to select for training according to at least one of the data augmentation indicators, the actual dataset size and the statistical information associated with data augmentation method. Accordingly, by using the data augmentation, the data collection entity is able to generate and provide more training datasets to the training entity based on the original data input sample. The data collection entity does not need to collect additional measurement data such as more CIRs, PDPs and RSRPs.

In some implementations, the training entity and the data collection entity may be implemented in the same apparatus. The apparatus may comprise at least one of a PRU, a UE, a base station, an LMF, a server and a network node. The communications between the training entity and the data collection entity are within the apparatus. Under such implementation, the apparatus may obtain the data input sample. For example, the apparatus may perform some measurements to acquire at least one of a CIR, a PDP and an RSRP. The apparatus may perform the data augmentation to generate the augmented training data based on the data input sample. The data augmentation may be performed by at least one of a jittering augmentation method, a timing shift augmentation method, an AI augmentation method and an ML augmentation method. Then, the apparatus may perform the model training on the positioning model based on the augmented training data. The apparatus may determine the position information of the apparatus by the positioning model. The position information may comprise an estimated location of the apparatus or a soft information related to the estimated location.

In some implementations, the data augmentation and the model training may be iteratively performed. Specifically, the training entity or the data collection entity may perform a first data augmentations based on the original dataset to generate a first augmented dataset. The first augmented dataset may be used to train the positioning model. Then, the training entity or the data collection entity may perform a first data augmentations based on the first augmented dataset to generate a second augmented dataset. The second augmented dataset may be used to train the positioning model again. By iterating the data augmentation and the model training, the performance of the positioning model can become more accurate.

In some implementations, when the model training is finished, an apparatus may be able to infer its position by using the positioning model. For example, the apparatus may receive a positioning reference signal (PRS) and use the positioning model to infer a position/location of the apparatus based on the PRS. In some implementations, when the scenario or position of the apparatus is changed, the apparatus may further determine whether to request new assistance data and/or re-train the positioning model.

In the present disclosure, several data augmentation method are proposed including transformation methods and AI methods. The transformation data augmentation techniques in the present disclosure take data input samples and synthesize new samples by modifying these data and applying different transformations. These transformations are applied directly to the data. Unlike transformation method, the AI methods are designed to learn the probability distribution of the data in order to generate completely new samples trying to imitate the data distribution. The AI methods may comprise, for example and not limited to, a Conditional Variational Autoencoding (CVAE) method.

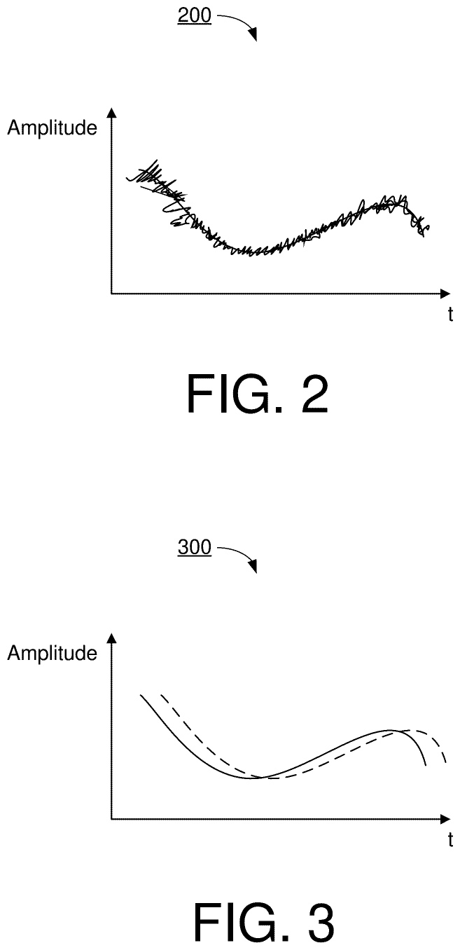

FIG. 2 illustrates an example jittering augmentation method 200 under schemes in accordance with implementations of the present disclosure. Jittering augmentation method 200 may be performed by at least one of a training entity and a data collection entity, which may be a part of a wireless communication network (e.g., an LTE network, a 5G/NR network, an IoT/NB-IoT/IIoT network, a 6G network and/or an NTN network). The jittering augmentation method consists of adding noise to CIRs/PDPs to perform data augmentation. In the present disclosure, it is assumed that the data are noisy which, in many cases, i.e., when dealing with received Positioning reference signal (PRS), is true. The jittering augmentation method tries to take advantage of the noise of the data and simulate it to generate new samples. Typically, Gaussian noise is added to each sample. The mean μ and standard deviation σ of this noise define the magnitude and shape of the deformation, therefore it is different in each application. The jittering process can be defined as follows,

$${X}^{′} ( ϵ ) = \{ {x}_{1} + {ϵ}_{1} , … , {x}_{𝔱} + {ϵ}_{𝔱} , … , {x}_{T} + {ϵ}_{T} \}$$

where ϵ stands for the noise addition vector at each sample, and it can be used as time-domain CIRs/PDPs/RSRPs, etc. x represents one sample consists of N fast Fourier transform (N-FFT) point CIR/PDP or one RSRP. In accordance with implementations of the present disclosure, x may be the measurement data (e.g., original data input sample) and X′ (ϵ) may be the augmented training data.

FIG. 3 illustrates an example timing shift augmentation method 300 under schemes in accordance with implementations of the present disclosure. Timing shift augmentation method 300 may be performed by at least one of a training entity and a data collection entity, which may be a part of a wireless communication network (e.g., an LTE network, a 5G/NR network, an IoT/NB-IoT/IIoT network, a 6G network and/or an NTN network). It is quite reasonable that network synchronization error or transmit/receive (TX/RX) timing error is included in the actual received data. The timing shift augmentation method tries to take advantage of the timing error of the data and simulate it to generate new samples. The timing shift is obtained by truncated Gaussian modelling with mean μ=0 and standard deviation of T1 nanosecond (ns), with truncation of the distribution to the [−2*T1, 2*T1] range. The timing shift process can be defined as follows,

$${X}^{′} ( Δ t ) = \{ {x}_{1 + Δt} , … , {x}_{t + Δ t} , … , {x}_{T + Δ t} \} ,$$

where Δt stands for the timing addition at each sample, and Δt∈ [−2*T1, 2*T1]. In accordance with implementations of the present disclosure, x may be the measurement data (e.g., initial data input sample) and X′ (Δt) may be the augmented training data.

In some implementations, the jittering/timing shift augmentation method may need to be adapted to each case, because there are cases where the effects of jittering/timing shift may lead to negative learning. That is, transformation methods for positioning performance improvement are strongly dependent on the quality of the original training dataset. The quality indicator of the training dataset may be reported from data generation/collection entity and/or as requested from a different entity. Take timing shift as an example, in order to enhance the performance, the standard deviation T1 used for data augmentation should not be selected with a large difference from the timing error of the original input data. Therefore, it should be selected carefully.

In some implementations, the positioning performance can be improved by data augmentation. Based on the quality indicator of the original dataset, the transformation methods can synthesize new samples approximating to the input dataset by adding noise/timing error conforming to the assumed distribution. For example, when the sampling signal is received, due to the limitation of sampling accuracy, there will be a timing error of ±0.5 sampling interval. Timing shift augmentation method can add a small time offset to each original sample to expand the dataset size. Due to the increase of training dataset size, the feature extraction of samples in the process of model training is more adequate, which finally leads to the improvement of the positioning performance.

In some implementations, the data augmentation can be used to improve positioning model's generalization performance. For example, when the positioning model is trained by a dataset with UE/gNB RX and TX timing error t1 (ns) and tested in a deployment scenario with UE/gNB RX and TX timing error t2 (ns), for a given t1, the positioning accuracy of cases with t2 smaller than t1 is better than the cases with t2 equal to t1. The positioning accuracy of cases with t2 greater than t1 is worse than the cases with t2 equal to t1. The larger the difference between t1 and t2, the more the degradation. To solve the problem that positioning accuracy degrades when model is tested in a deployment scenario with timing error t2 greater than t1, timing error with truncated Gaussian distribution may be added to the training dataset of timing error t1, so that the timing error of the generated new data may be increased to t2. Through data augmentation, with the absence of training data of timing error t2, target dataset can still be generated to retrain the positioning model to improve performance in the deployment scenarios.

The improvement of positioning model's generalization performance based on data augmentation is due to the lower signal-to-noise ratio (SNR) of test dataset than that of training dataset or the greater timing error of test dataset than that of training dataset. That is, the quality of test dataset is lower than that of training dataset. When the quality of the test dataset is higher than that of the training dataset, the generalization performance of the model can be guaranteed.

In addition to the transformation augmentation methods mentioned above, AI augmentation method (e.g., Variational Autoencoding (VAE)) may also be used for data augmentation. VAE is a generative model that learns to generate new data by mapping the data onto a lower dimensional space (encoding) and then back to the original space (decoding), while simultaneously learning the distribution of the latent variables. It is a type of neural network that uses a probabilistic approach to model the data distribution. VAE learns to generate new data by sampling from the learned latent space. CVAE extends VAE to a conditional generative model. This means that the generated output is conditioned on additional information, such as class labels or input data. In a CVAE, an additional set of conditioning variables is incorporated into both the encoder and decoder networks. In the present disclosure, CVAE data augmentation method may be used to improve the positioning performance.

In some implementations, the training entity may estimate the location via a direct AI/ML positioning model. The training entity may use the measurement data or original data (e.g., CIR, PDP or RSRP) as the input of the direct AI/ML positioning model. The direct AI/ML positioning model may output the estimated location directly. Alternatively, the training entity may estimate the location via an AI/ML assisted positioning model. The AI/ML assisted positioning model may be used to estimate a timing information, a line of sight (LOS)/non-LOS (NLOS) indication, a time of arrival (TOA) parameter or a time difference of arrival (TDOA) parameter. The LOS indicator may indicate that a corresponding path between the training entity and the network node is LOS. The NLOS indicator may indicate that a corresponding path between the training entity and the network node is NLOS. The TOA parameter is the TOA for the path between the network node and the training entity. The training entity may determine the estimated location by using the output of the AI/ML assisted positioning model. For example, the training entity may determine the estimated location according to the LOS indicator, the location of the network node (e.g., which may be transmitted from the network node) and the TOA parameter.

In accordance with the solutions proposed in the present disclosure, the training dataset for a positioning model may be expanded/produced based on the original dataset via data augmentation methods. Thus, only a part of original dataset (e.g., 5%-10%) is needed to train the positioning model and improve the accuracy of the positioning model. The efforts and time for collecting original dataset can be significantly reduced. The performance of positioning model can be increased.

### Illustrative Implementations

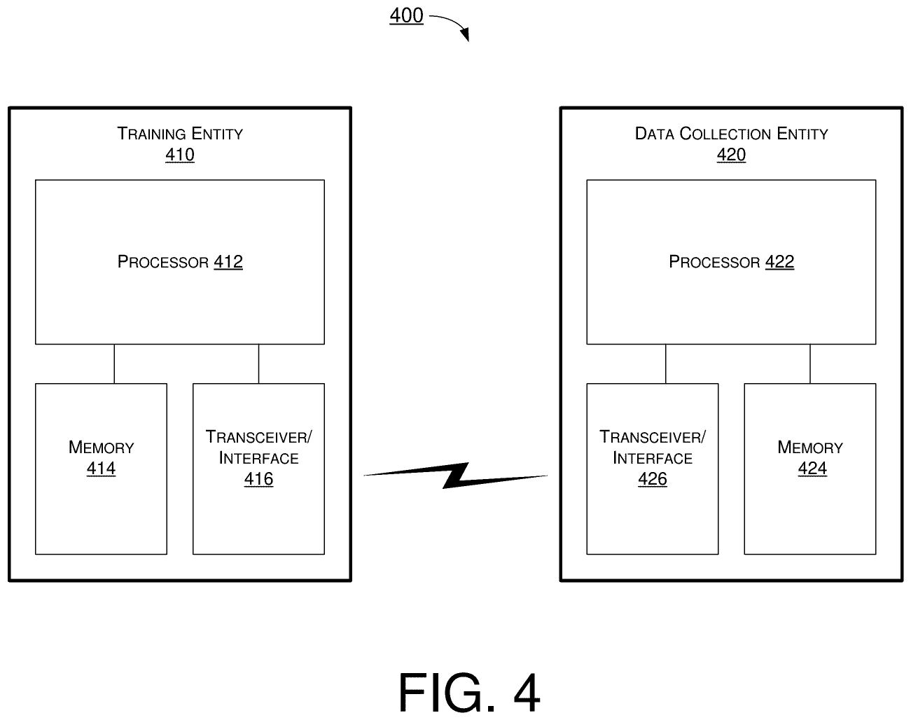

FIG. 4 illustrates an example positioning system 400 having an example training entity/apparatus 410 and an example data collection entity/apparatus 420 in accordance with an implementation of the present disclosure. Each of training entity/apparatus 410 and data collection entity/apparatus 420 may perform various functions to implement schemes, techniques, processes and methods described herein pertaining to improving positioning by data augmentation with respect to user equipment and network apparatus in mobile communications, including scenarios/schemes described above as well as process 500, process 600 and process 700 described below.

Training entity 410 or data collection entity 420 may be a part of an electronic apparatus, which may be a UE such as a portable or mobile apparatus, a wearable apparatus, a wireless communication apparatus or a computing apparatus. For instance, training entity 410 or data collection entity 420 may be implemented in a smartphone, a smartwatch, a personal digital assistant, a digital camera, or a computing equipment such as a tablet computer, a laptop computer or a notebook computer. Training entity 410 or data collection entity 420 may also be a part of a machine type apparatus, which may be an IoT, NB-IoT, or IIoT apparatus such as an immobile or a stationary apparatus, a home apparatus, a wire communication apparatus or a computing apparatus. For instance, training entity 410 or data collection entity 420 may be implemented in a smart thermostat, a smart fridge, a smart door lock, a wireless speaker or a home control center. Alternatively, training entity 410 or data collection entity 420 may be a part of a network apparatus, which may be a network node such as a satellite, a base station, a small cell, a router, a gateway a positioning reference unit, a location management function or a server. For instance, training entity 410 or data collection entity 420 may be implemented in an eNodeB in an LTE network, in a gNB in a 5G/NR, IoT, NB-IoT or IIoT network or in a satellite or base station in a 6G network.

In some implementations, training entity 410 or data collection entity 420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Training entity 410 or data collection entity 420 may include at least some of those components shown in FIG. 4 such as a processor 412 or 422 and a transceiver/interface 416 or 426, for example. Transceiver/interface 416 or 426 may be used to communicate with other apparatus/entities. Training entity 410 or data collection entity 420 may further include one or more other components not pertinent to the proposed scheme of the present disclosure (e.g., internal power supply, display device and/or user interface device), and, thus, such component(s) of training entity 410 or data collection entity 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including data augmentation in a device (e.g., as represented by training entity 410 or data collection entity 420) in accordance with various implementations of the present disclosure.

In some implementations, training entity 410 may also include a transceiver/interface 416 coupled to processor 412 and capable of transmitting and receiving data. In some implementations, training entity 410 may further include a memory 414 coupled to processor 412 and capable of being accessed by processor 412 and storing data therein. In some implementations, data collection entity 420 may also include a transceiver/interface 426 coupled to processor 422 and capable of transmitting and receiving data. In some implementations, data collection entity 420 may further include a memory 424 coupled to processor 422 and capable of being accessed by processor 422 and storing data therein. Accordingly, training entity 410 and data collection entity 420 may communicate with each other via transceiver/interface 416 and transceiver/interface 426, respectively. To aid better understanding, the following description of the operations, functionalities and capabilities of each of training entity 410 and data collection entity 420 is provided in the context of a mobile communication environment in which training entity 410 and data collection entity 420 is implemented in or as a communication apparatus, a UE or a network node of a communication network.

In some implementations, processor 412 may transmit, via the transceiver/interface 416, a request for an assistance data to data collection entity 420. Processor 412 may receive, via the transceiver/interface 416, the assistance data from data collection entity 420. Processor 412 may perform a model training on a positioning model based on the assistance data. Processor 412 may determine a position information by the positioning model.

In some implementations, the assistance data comprises at least one of a set of delay profiles of channels, a set of labels labelling each delay profile, a set of quality indicators of the delay profiles and the labels, a set of augmented training data, a set of data augmentation indicators for the augmented training data, a set of parameters or timing shift values associated with the augmented training data, an actual dataset size, and statistical information associated with a data augmentation method.

In some implementations, training entity 410 may comprise at least one of a PRU, a UE, a base station, an LMF, a server and a network node.

In some implementations, the request may comprise at least one of a data augmentation indicator to indicate a type of data augmentation needed, a needed/preferred dataset size, and statistical information associated with a data augmentation method.

In some implementations, processor 412 may perform a data augmentation to generate an augmented training data based on the assistance data. Processor 412 may perform the model training based on the augmented training data.

In some implementations, processor 412 may perform the data augmentation by at least one of a jittering augmentation method, a timing shift augmentation method, an AI augmentation method and an ML augmentation method. The AI augmentation method may comprise a Conditional Variational Autoencoding (CVAE) method.

In some implementations, processor 412 may obtaining, via the transceiver/interface 416, a data input sample. Processor 412 may transmit, via the transceiver/interface 416, the data input sample to data collection entity 420. The assistance data may be associated to the data input sample.

In some implementations, processor 412 may requesting, via the transceiver/interface 416, at least one label for the data input sample. Processor 412 may perform a data augmentation to generate an augmented training data based on the at least one label and the data input sample.

In some implementations, the position information may comprise an estimated location of the training entity or a soft information related to the estimated location.

In some implementations, processor 422 may receive, via the transceiver/interface 426, a request for an assistance data from training entity 410. Processor 422 may generate the assistance data according to the request. Processor 422 may transmit, via the transceiver/interface 426, the assistance data to training entity 410.

In some implementations, data collection entity 420 may comprise at least one of a PRU, a UE, a base station, an LMF, a server and a network node.

In some implementations, processor 422 may perform a data augmentation to generate the augmented training data.

In some implementations, processor 422 may perform the data augmentation by at least one of a jittering augmentation method, a timing shift augmentation method, an AI augmentation method and an ML augmentation method. The AI augmentation method may comprise a Conditional Variational Autoencoding (CVAE) method.

In some implementations, processor 422 may obtain, via the transceiver/interface 426, a data input sample. Processor 422 may add at least one label for the data input sample. The assistance data may be associated to the data input sample and the at least one label.

In some implementations, training entity 410 and data collection entity 420 may be implemented in the same apparatus. In some implementations, a processor of the apparatus, may obtain a data input sample. The processor may perform a data augmentation to generate an augmented training data based on the data input sample. The processor may also perform a model training on a positioning model based on the augmented training data. The processor may determine a position information of the apparatus by the positioning model.

In some implementations, the apparatus may comprise at least one of a PRU, a UE, a base station, an LMF, a server and a network node.

In some implementations, the data input sample obtained by the apparatus may comprise at least one of a CIR, a PDP and an RSRP.

In some implementations, the apparatus may perform the data augmentation by at least one of a jittering augmentation method, a timing shift augmentation method, an AI augmentation method and an ML augmentation method. The AI augmentation method may comprise a Conditional Variational Autoencoding (CVAE) method.

In some implementations, the position information determined by the apparatus may comprise an estimated location of the apparatus or a soft information related to the estimated location.

### Illustrative Processes

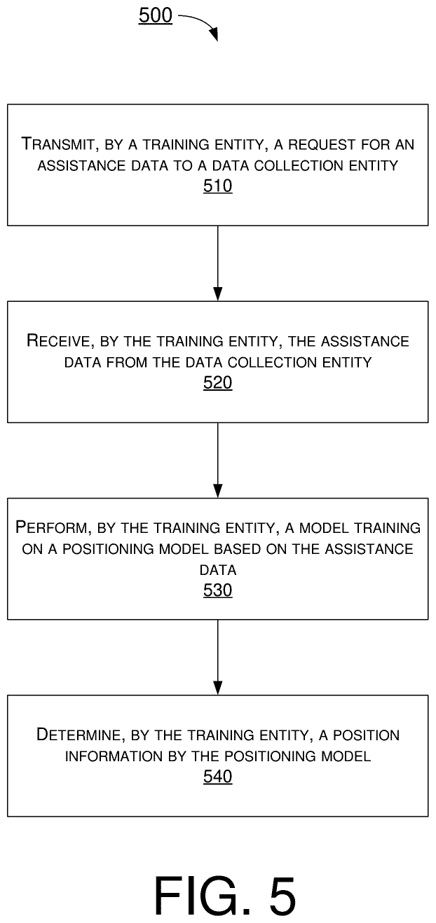

FIG. 5 illustrates an example process 500 in accordance with an implementation of the present disclosure. Process 500 may be an example implementation of above scenarios/schemes, whether partially or completely, with respect to improving positioning by data augmentation of the present disclosure. Process 500 may represent an aspect of implementation of features of training entity 410. Process 500 may include one or more operations, actions, or functions as illustrated by one or more of blocks 510 to 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by training entity 410 or any suitable UE or network node. Solely for illustrative purposes and without limitation, process 500 is described below in the context of training entity 410. Process 500 may begin at block 510.

At block 510, process 500 may involve training entity 410 transmitting a request for an assistance data to a data collection entity. Process 500 may proceed from block 510 to block 520.

At block 520, process 500 may involve training entity 410 receiving the assistance data from the data collection entity. Process 500 may proceed from block 520 to block 530.

At block 530, process 500 may involve training entity 410 performing a model training on a positioning model based on the assistance data. Process 500 may proceed from block 530 to block 540.

At block 540, process 500 may involve training entity 410 determining a position information by the positioning model.

In some implementations, process 500 may further involve training entity 410 performing a data augmentation to generate an augmented training data based on the assistance data. Process 500 may further involve training entity 410 performing the model training based on the augmented training data.

In some implementations, process 500 may further involve training entity 410 obtaining a data input sample. Process 500 may further involve training entity 410 transmitting the data input sample to the data collection entity.

In some implementations, process 500 may further involve training entity 410 requesting at least one label for the data input sample. Process 500 may further involve training entity 410 perform a data augmentation to generate an augmented training data based on the at least one label and the data input sample.

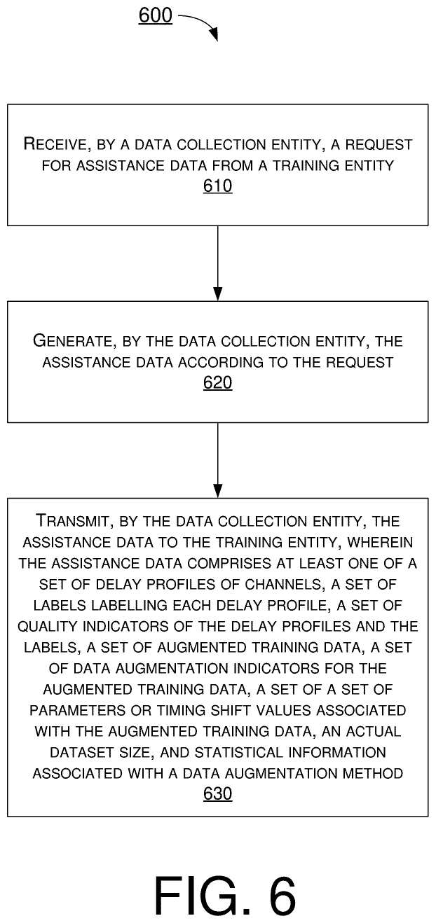

FIG. 6 illustrates an example process 600 in accordance with an implementation of the present disclosure. Process 600 may be an example implementation of above scenarios/schemes, whether partially or completely, with respect to improving positioning by data augmentation of the present disclosure. Process 600 may represent an aspect of implementation of features of data collection entity 420. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by data collection entity 420 or any suitable UE or network node. Solely for illustrative purposes and without limitation, process 600 is described below in the context of data collection entity 420. Process 600 may begin at block 610.

At block 610, process 600 may involve data collection entity 420 receiving a request for an assistance data from a training entity. Process 600 may proceed from block 610 to block 620.

At block 620, process 600 may involve data collection entity 420 generating the assistance data according to the request. Process 600 may proceed from block 620 to block 630.

At block 630, process 600 may involve data collection entity 420 transmitting the assistance data to the training entity. The assistance data may comprise at least one of a set of delay profiles of channels, a set of labels labelling each delay profile, a set of quality indicators of the delay profiles and the labels, a set of augmented training data, a set of data augmentation indicators for the augmented training data, a set of parameters or timing shift values associated with the augmented training data, an actual dataset size, and statistical information associated with a data augmentation method.

In some implementations, process 600 may further involve data collection entity 420 performing a data augmentation to generate the augmented training data.

In some implementations, process 600 may further involve data collection entity 420 obtaining a data input sample. Process 600 may further involve data collection entity 420 add at least one label for the data input sample. The assistance data may be associated to the data input sample and the at least one label.

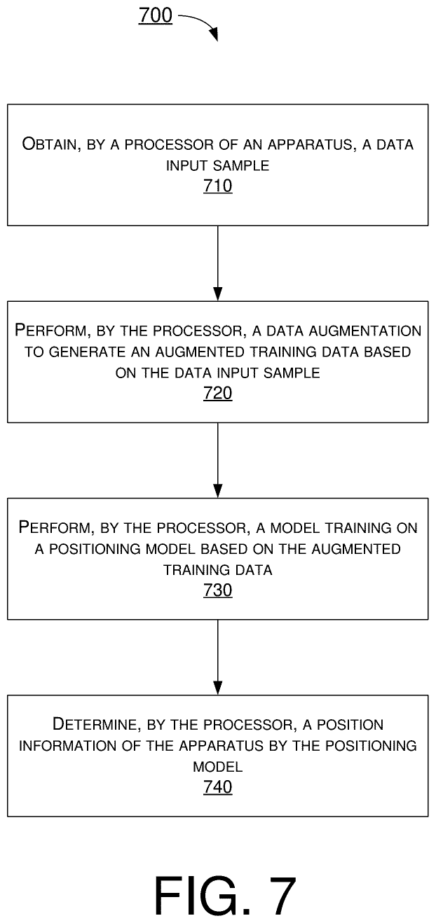

FIG. 7 illustrates an example process 700 in accordance with an implementation of the present disclosure. Process 700 may be an example implementation of above scenarios/schemes, whether partially or completely, with respect to improving positioning by data augmentation of the present disclosure. Process 700 may represent an aspect of implementation of features of an apparatus comprising training entity 410 and data collection entity 420. Process 700 may include one or more operations, actions, or functions as illustrated by one or more of blocks 710 to 740. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by a communication apparatus or any suitable UE or network node. Solely for illustrative purposes and without limitation, process 700 is described below in the context of a communication apparatus. Process 700 may begin at block 710.

At block 710, process 700 may involve a processor of an apparatus obtaining a data input sample. Process 700 may proceed from block 710 to block 720.

At block 720, process 700 may involve the processor performing a data augmentation to generate an augmented training data based on the data input sample. Process 700 may proceed from block 720 to block 730.

At block 730, process 700 may involve the processor performing a model training on a positioning model based on the augmented training data. Process 700 may proceed from block 730 to block 740.

At block 740, process 700 may involve the processor determining a position information of the apparatus by the positioning model.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a training entity, a request for an assistance data to a data collection entity;
receiving, by the training entity, the assistance data from the data collection entity;
performing, by the training entity, a model training on a positioning model based on the assistance data; and
determining, by the training entity, a position information by the positioning model.

2. The method of claim 1, wherein the assistance data comprises at least one of:
a set of delay profiles of channels;
a set of labels labelling each delay profile;
a set of quality indicators of the delay profiles and the labels;
a set of augmented training data;
a set of data augmentation indicators for the augmented training data;
a set of parameters or timing shift values associated with the augmented training data;
an actual dataset size; and
statistical information associated with a data augmentation method.

3. The method of claim 1, wherein the training entity comprises at least one of a positioning reference unit (PRU), a user equipment (UE), a base station, a location management function (LMF), a server and a network node.

4. The method of claim 1, wherein the request comprises at least one of a data augmentation indicator to indicate a type of data augmentation needed, a preferred dataset size, and statistical information associated with a data augmentation method.

5. The method of claim 1, further comprising:
performing, by the training entity, a data augmentation to generate an augmented training data based on the assistance data,
wherein the model training is performed based on the augmented training data.

6. The method of claim 5, wherein the data augmentation is performed by at least one of a jittering augmentation method, a timing shift augmentation method, an artificial intelligence (AI) augmentation method and a machine learning (ML) augmentation method.

7. The method of claim 6, wherein the AI augmentation method comprises a Conditional Variational Autoencoding (CVAE) method.

8. The method of claim 1, further comprising:
obtaining, by the training entity, a data input sample; and
transmitting, by the training entity, the data input sample to the data collection entity,
wherein the assistance data is associated to the data input sample.

9. The method of claim 8, further comprising:
requesting, by the training entity, at least one label for the data input sample; and
performing, by the training entity, a data augmentation to generate an augmented training data based on the at least one label and the data input sample.

10. The method of claim 1, wherein the position information comprises an estimated location of the training entity or a soft information related to the estimated location.

11. A method, comprising:
receiving, by a data collection entity, a request for an assistance data from a training entity;
generating, by the data collection entity, the assistance data according to the request; and
transmitting, by the data collection entity, the assistance data to the training entity,
wherein the assistance data comprises at least one of:
a set of delay profiles of channels;
a set of labels labelling each delay profile;
a set of quality indicators of the delay profiles and the labels;
a set of augmented training data;
a set of data augmentation indicators for the augmented training data;
a set of parameters or timing shift values associated with the augmented training data;
an actual dataset size; and
statistical information associated with a data augmentation method.

12. The method of claim 11, wherein the data collection entity comprises at least one of a positioning reference unit (PRU), a user equipment (UE), a base station, a location management function (LMF), a server and a network node.

13. The method of claim 11, further comprising:
performing, by the data collection entity, a data augmentation to generate the augmented training data.

14. The method of claim 13, wherein the data augmentation is performed by at least one of a jittering augmentation method, a timing shift augmentation method, an artificial intelligence (AI) augmentation method and a machine learning (ML) augmentation method.

15. The method of claim 11, further comprising:
obtaining, by the data collection entity, a data input sample; and
adding, by data collection entity, at least one label for the data input sample,
wherein the assistance data is associated to the data input sample and the at least one label.

16. A method, comprising:
obtaining, by a processor of an apparatus, a data input sample;
performing, by the processor, a data augmentation to generate an augmented training data based on the data input sample;
performing, by the processor, a model training on a positioning model based on the augmented training data; and
determining, by the processor, a position information of the apparatus by the positioning model.

17. The method of claim 16, wherein the apparatus comprises at least one of a positioning reference unit (PRU), a user equipment (UE), a base station, a location management function (LMF), a server and a network node.

18. The method of claim 16, wherein the data input sample comprises at least one of a channel impulse response (CIR), a power delay profile (PDP) and a reference signal received power (RSRP).

19. The method of claim 16, wherein the data augmentation is performed by at least one of a jittering augmentation method, a timing shift augmentation method, an artificial intelligence (AI) augmentation method and a machine learning (ML) augmentation method.

20. The method of claim 16, wherein the position information comprises an estimated location of the apparatus or a soft information related to the estimated location.
